(19) United States
(12) Patent Application Publication
(10) Pub. No.: US 2017/0203967 A1
(43) Pub. Date: Jul. 20, 2017

(54) METHOD AND APPARATUS FOR PRODUCING NANOMATERIAL

(71) Applicant: Canatu Oy, Helsinki (FI)

(72) Inventors: David P. Brown, Helsinki (FI); Olivier Reynaud, Kauniainen (FI); Anton Sergeevich Anisimov, Espoo (FI); Bjørn Friður Mikladal, Helsinki (FI); Ilkka Varjos, Espoo (FI)

(73) Assignee: Canatu Oy, Helsinki (FI)

(21) Appl. No.: 15/313,839

(22) PCT Filed: May 23, 2014
(86) PCT No.: PCT/FI2014/050404

§ 371 Date: Nov. 23, 2016

(51) Int. Cl. C01B 31/02; B01J 12/02; C23C 18/02; B01J 12/00; B01J 19/24

(52) U.S. Cl. CPC C01B 31/0233; B01J 12/005; B01J 12/02; B01J 12/007; B01J 19/2415; C23C 18/02; B82Y 40/00

(57) ABSTRACT

A method for producing nanomaterial comprising carbon is disclosed. The method comprises introducing a combination of two or more carbon sources into a synthesis reactor; decomposing at least partially the two or more carbon sources in the synthesis reactor to release carbon from the two or more carbon sources; and synthesizing the nanomaterial comprising carbon from the released carbon in the synthesis reactor.

### FIELD OF THE INVENTION

The present invention relates to synthesis of nanomaterials. More specifically, the present invention relates to methods and apparatuses for producing nanomaterial comprising carbon.

### BACKGROUND OF THE INVENTION

Transparent and conductive or semiconductive thin films are important for many applications, such as transistors, printed electronics, touch screens, sensors, photonic devices, electrodes for solar cells lightning, sensing and display devices. Thicker and porous films can also be useful for batteries, supercapacitors, fuel cells, solar cells and water and air purifiers and filters. As synthesis and film fabrication processes improve, the structures exhibit increasing performance and reduced cost. For example, for transparent electrodes, conductivity and transparency performance of Carbon Nanotube (CNTs) and Carbon NanoBud® (CNB) films is approaching that of indium tin oxide (ITO) films. Among the main advantages of High Aspect Ratio Molecular (HARM) thin films over ITO thin layers are their flexibility and potential for reduced material and synthesis costs. Carbon based HARM structures in particular have low reflectivity, high raw material availability and low cost. In many cases, HARM thin films can be deposited on thin flexible substrates in order to obtain transparent and flexible components and devices, while ITO is a brittle material that usually has to be deposited on rigid and/or thick substrates. Furthermore, the cost of carbon based films relies on carbon supplies which are cheap and easily available. State-of-the-art carbon based films produced via CO disproportionation have been shown to have superior properties, however, the underlying CO disproportionation reaction is relatively slow and produces low yield in terms of conversion of CO into nanocarbon, thus increasing manufacturing cost and limiting industrial applications. In order to increase the yield of CO-based reactors, CO processes have been run at high pressure, however, this is undesirable due to reduced safety and increased cost.

### PURPOSE OF THE INVENTION

The purpose of the present invention is to overcome the difficulties of existing techniques in the synthesis of nanomaterials comprising carbon.

The present invention provides a new and improved method and apparatus which can be used for synthesis of nanomaterial comprising carbon in commercial quantities without the cost, safety, yield and quality limitations of existing methods.

### SUMMARY OF THE INVENTION

In this section, the main embodiments of the present invention as defined in the claims are described and certain definitions are given.

According to a first aspect of the present invention, a method for producing nanomaterial comprising carbon is disclosed. The method comprises: introducing a combination of two or more carbon sources into a synthesis reactor; decomposing at least partially the two or more carbon sources in the synthesis reactor to release carbon from the two or more carbon sources; and synthesizing the nanomaterial comprising carbon from the released carbon in the synthesis reactor. The method can be performed in a continuous flow, in batch or as a combination of batch and continuous sub-processes.

Nanomaterials comprising carbon cover a wide range of structures and morphologies including films, platelets such as graphene, spheres or spheroids such as nanoonions, fullerenes and buckyballs; fibers and more complex shapes such as carbon nanotrees, nanohorns, nanoribbons, nanocones, graphinated carbon nanotubes, carbon peapods, carbon nitrogen nanotubes and carbon boron nanotubes.

A carbon source is here understood to mean any material which contains carbon that can be released for the formation of nanomaterials comprising carbon. A carbon source can be carbon or carbon containing compounds including, but not limited to, carbon monoxide, alcohols, hydrocarbons and carbohydrates. More particularly, carbon sources may include, but are not limited to, gaseous carbon compounds such as methane, ethane, propane, ethylene, acetylene as well as liquid volatile carbon sources as benzene, toluene, xylenes, trimethylbenzenes, methanol, ethanol, octanol, sugars (sucrose), acitates, isopropylic alcohol, cyclohexane, turpentine, neem oil, coconut oil or acetonitrile, saturated hydrocarbons (e.g. CH₄, C₂H₆, C₃H₈), systems with saturated carbon bonds from C₂H₂ via C₂H₄ to C₂H₆ aromatic compounds (o-xylene C₆H₄—(CH₃)₂, 1,2,4-trimethylbenzene C₆H₃—(CH₃)₃) fullerene molecules can be also used as a carbon source. Nevertheless, all of the presented compounds and many other carbon containing molecules can be used as a carbon source in the present invention. Other carbon sources are possible and these examples are not intended to limit the scope of the invention in any way.

Two or more carbon sources used in a combination provide the advantage of higher yield, improved process robustness and increased quality of the resulting carbon nanomaterial as compared to a single source. The combination of two or more sources also allows for more flexibility in the choice of parameters and conditions of synthesis.

According to an embodiment, decomposing at least partially the two or more carbon sources in the synthesis reactor to release carbon from the two or more carbon sources is done by providing energy to the synthesis reactor and/or by introducing a decomposing reagent.

Energy can be provided to the synthesis reactor in any form suitable to communicate energy to the carbon sources or to otherwise release carbon. A source of this energy can be, for instance, electrical, conductive, inductive, resistive, radio-frequency, microwave, vibrational, mechanical, or acoustic sources, laser induction, convective or radiative heating, combustion or chemical reaction, nuclear fission or fusion. Chemical reaction can also be used to release carbon from the carbon source.

A decomposing reagent is here understood to mean any chemical that induces decomposition of one or more of the two or more carbon sources to release carbon.

According to an embodiment of the present invention, the method further comprises introducing one or more promoters into the reactor.

A promoter is here understood to cover all materials in gaseous, liquid, solid or aerosol form which improve the growth rate of nanomaterials and/or aid in controlling one or more property of the synthesized nanomaterial comprising carbon. A promoter herein may refer to a promoter material or promoter precursor which provides promoter material to the synthesis reactor. Promoters may include, for instance, sulfur, phosphorus or nitrogen elements or their compounds. Examples of promoters include, but are not limited to, thiophene, dimethyl sulphide, water, sulphur, selenium, tellurium, gallium, germanium, phosphorous, lead, bismuth, oxygen, hydrogen, ammonia, an alcohol, a thiol, ether, a thioether, an ester, a thioester, an amine, a ketone, a thioketone, an aldehyde, a thioaldehyde, and carbon dioxide. Other promoters are possible according to the invention.

Using a promoter can provide improved growth rate, modification of a chemical property, a modification of the nanomaterial morphology or structure and/or improved control over properties of the resulting nanomaterials, such as chiral angle or diameter.

According to an embodiment, the method further comprises introducing one or more catalysts into the reactor, wherein the nanomaterial comprising carbon is synthesized from the released carbon and the one or more catalysts. Promoters can act to, for instance, improve catalyst performance, activate catalysts, reactivate catalyst, control catalyst morphology, or control solubility of carbon in the catalyst material.

A catalyst is here understood to cover all materials in gaseous, liquid, solid, aquasol or aerosol form that can be used to catalyze the growth of nanomaterials comprising carbon. A catalyst may also refer to a catalyst precursor which can be treated to produce a catalyst material prior to or during the synthesis.

It should be noted that the release of carbon from the two or more sources can occur without the presence of catalyst particles according to the present invention. However, since decomposition of carbon sources resulting in released carbon is typically a kinetically limited process, catalyst particles may provide an improved decomposition rate, particularly at moderate temperatures, low or moderate pressures and relatively low residence times. Catalyst particles, if used, may be produced as part of the process or can come from an existing source.

According to an embodiment of the present invention, the method further comprises purifying the synthesized nanomaterial comprising carbon by introducing a purifying reagent.

Purification can be done, for example, to remove undesirable amorphous carbon coatings and/or catalyst particles encapsulated in the carbon nanomaterial. Examples of purifying reagents include alcohols, ketones, organic and inorganic acids. Purifying agents can also include processes such as sonication or separation. Other reagents are possible according to the present invention.

According to an embodiment of the present invention, the method further comprises functionalizing the synthesized nanomaterial comprising carbon by introducing a functionalizing reagent.

A functionalizing reagent can be used to attach one or more chemical groups to the nanomaterial comprising carbon to alter its properties. According to the present invention, the functionalizing reagent can be introduced before, during or after the nanomaterial synthesis.

According to an embodiment, at least one of the carbon sources is introduced as a liquid, aerosol or gas into the synthesis reactor.

According to an embodiment, at least one of the carbon sources is selected from a group of: elemental carbon, a molecule or polymer containing one or more carbon atoms SP, SP2 or SP3 bonded to each other and/or to oxygen, one or more hydroxyl groups, nitrogen, one or more nitroso groups, one or more amine groups and/or one or more sulfonate groups, an organic compound, an oxide of carbon, a carbide, a carbonate and a cyanide.

According to an embodiment, one or more of the above organic compounds is a hydrocarbon or a carbohydrate.

According to an embodiment, the catalyst is a bulk metal or alloy, or a material comprising a metal or an alloy.

Various metals (e.g. transition metals) which catalyze the process of carbon source decomposition or disproportionation can be used as catalysts. Examples of catalysts according to this embodiment include, but are not limited to, metals such as iron, nickel, cobalt, platinum, palladium, chromium, copper, molybdenum, silver or gold and mixtures or compounds containing them (e.g. metallorganic or organometallic compounds, metallocene compounds, metal containing proteins, carbonyl compounds chelate compounds, and metal salts, cyonides, acitates, carbides, nitrides, chlorides, bromides, sulfates, carbonyls and oxides). Examples include but are not limited to ferrocene, iron pentacarbonyl, nickelecene, cobaltocene, tetracarbonyl nickel, organomagnesium compounds such as iodo(methyl)magnesium MeMgI, diethylmagnesium (Et2Mg), Grignard reagents, methylcobalamin hemoglobin, myoglobin, cytochrome, organolithium compounds such as n-butyllithium (n-BuLi), organozinc compounds such as diethylzinc (Et2Zn) and chloro(ethoxycarbonylmethyl)zinc (ClZnCH2C(═O)OEt) and organocopper compounds such as lithium dimethylcuprate (Li+[CuMe2]—), metal beta-diketonates, alkoxides, and dialkylamides, acetylacetonates, metal alkoxides, lanthanides, actinides, and semimetals, triethylborane (Et3B). As it is clear to a skilled person, other materials can be used as catalysts according the present invention and the preceding examples are not intended to limit the scope of the invention in any way.

According to an embodiment, energy is provided into the synthesis reactor by heating.

According to an embodiment, a combination of two carbon sources including a first carbon source and a second carbon source is introduced into the synthesis reactor.

According to an embodiment, the molar ratio of the first carbon source to the second carbon source in the synthesis reactor is between 1:1000000 and 1000000:1.

According to an embodiment, a combination of three carbon sources is introduced into the synthesis reactor.

The use of three or more carbon sources is advantageous in certain circumstances, in particular, to widen to acceptable operating range of the synthesis reactor so as to further increase the yield, production rate or robustness of the synthesis process.

According to an embodiment, at least one of the carbon sources is carbon monoxide (CO). Not to be bound by theory, carbon monoxide is advantageous due to, for instance, its tendency to decompose only at the catalyst surface and thus minimize the production of undesirable by-products such as amorphous carbon.

According to an embodiment, at least one of the carbon sources is ethylene, styrene or toluene. Not to be bound by theory, these compounds are advantageous in combination with CO, for instance, due to their different (usually higher) decomposition temperature and thus their ability to widen the temperature operating window of the synthesis process.

According to an embodiment, the nanomaterial comprising carbon is a high aspect ratio molecular (HARM) material comprising carbon, graphene or fullerene or combinations or hybrids of nanomaterial comprising carbon.

According to an embodiment, the above HARM material is a carbon nanotube (CNT), a carbon nanobud (CNB), a carbon nanowire, a carbon nanoribbon, a graphinated, carbon nanotube, a carbon nanohorn, a carbon fiber, a carbon peapod, a carbon nitrogen nanotube or a carbon boron nanotube or their combinations or hybrids.

The nanomaterials comprising carbon synthesized by the method according to the present invention can be efficiently used in, for instance, transparent conductions, transistors, displays, solar cells, speakers, batteries, supercapacitors, electromagnetic shields, electrostatic dissipation, sensors of, for instance, temperature or chemical compounds, heat pipes or heat sinks, gas or particles filters, and microfluidic devices.

The nanomaterials comprising carbon can have a minimum characteristic length of between 0.1 and 100 nm. For instance, in the case of a nanotube, NanoBud or nanorod, the characteristic length is the diameter.

According to a second aspect of the present invention, an apparatus is disclosed. The apparatus comprises means for performing the method according to any of the embodiments described above.

### BRIEF DESCRIPTION OF THE DRAWINGS

For a more complete understanding of example embodiments of the present invention, reference is now made to the following descriptions taken in connection with the accompanying drawings in which:

FIG. 1 shows the method according to an embodiment of the present invention.

FIG. 2 is a graph showing the improved performance of CNT material by the use of multiple carbon sources according to the invention.

### DETAILED DESCRIPTION OF THE INVENTION

An explanation of the main principles of the present invention follows based on the examples described below. These examples are for purposes of illustration only and are not intended to limit the scope of the invention in any way.

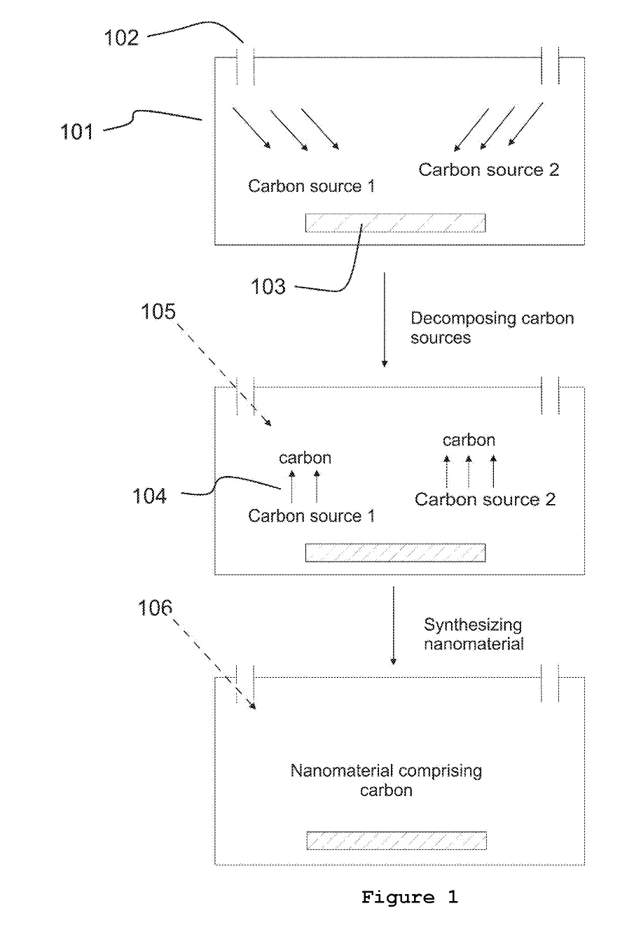

A method according to an exemplary embodiment of the invention is shown in FIG. 1. The method is carried out in a synthesis reactor 101. Two or more carbon sources are first introduced into the synthesis reactor. There are two carbon sources shown in FIG. 1, namely carbon source 1 and carbon source 2, however the present invention is not limited to two sources of carbon and may include three, four, five or more. It may be preferable that the carbon sources may have similar or different behavior in the synthesis reactor. For instance, it may be preferable that the two or more carbon sources have different decomposition temperatures or chemical decomposition dynamics so that, even if the reactor conditions vary in time or in space, synthesis of the nanomaterial can proceed uninterrupted or at an optimal or near optimal condition, thus improving the robustness of the production process. The carbon sources are materials which contain carbon that can be released for the formation of nanomaterials comprising carbon. For example, a carbon source can be carbon or carbon containing compounds including, but not limited to, carbon monoxide, alcohols, hydrocarbons and carbohydrates. An example of a carbon source is ethylene, styrene, toluene, and carbon monoxide. In case of two carbon sources, the molar ratio of the first carbon source to the second carbon source may vary between 1:1000000 and 1000000:1.

At least one of the carbon sources 1 and 2 may be introduced into the synthesis reactor 101 via an inlet 102. The inlet 102 may be a pipe, a nozzle or any other suitable structure. The carbon sources can be carbon or carbon containing compounds including, but not limited to, carbon monoxide, alcohols, hydrocarbons and carbohydrates. The carbon sources can be introduced as a liquid, aerosol, gas, aquasol or a solid substance.

According to the method, a means of releasing carbon from the carbon sources by carbon source decomposition is provided. According to the embodiment shown on FIG. 1, the synthesis reactor 101 may also comprise an energy source 103, for example a heater. Other energy sources are available according to the invention, for example (but not limited to) electrical, conductive, inductive, resistive, radio-frequency, electromagnetic radiation, laser, microwave, vibrational, mechanical, or acoustic sources. The energy source 103 is can be located inside the synthesis reactor 101, as shown in the Figure, or it may be part of the synthesis reactor 101 or located outside of it. Reactants can also be introduced into the reactor to react with a carbon source to release carbon or transform the carbon source into a form from which carbon can be more easily or more controllably released.

Next, energy may be provided to the reactor 101. The energy can be provided from any of the above listed sources or by other means from the energy source 103. When energy is provided and communicated to the carbon sources, carbon is released from the carbon sources as indicated by step 104. The carbon in step 104 may be released from both sources simultaneously or from one at a time, i.e. in a sequence. The combination of two or more sources increases the range of conditions in which carbon can be released into the synthesis reactor 101.

A chemical reagent that causes decomposition 104 of the carbon sources to release carbon can be provided into the reactor 101 in addition to, or instead of, the energy produced by the energy source 103.

A promoter and/or a catalyst may be introduced into the synthesis reactor 101 in an optional step 105 (as shown by a dashed arrow). The promoter and/or catalyst may be introduced before providing energy into the reactor 101, during this step or after this step. The promoter and/or catalyst may be introduced as pre-made promoter and/or catalyst particles, or as promoter and/or catalyst precursor particles which can be converted into promoter and/or catalyst particles in the synthesis reactor 101.

A catalyst can be heated to decompose and release or synthesize the catalyst material to form a catalyst particle. Alternatively, a catalyst precursor can be put in contact with a reagent to react with the catalyst precursor to synthesize the catalyst material to form a catalyst particle. Other means of conditioning a catalyst particle precursor particle is possible according to the invention. For the production of nanomaterials comprising carbon with further controlled properties, the catalyst particles can be classified according to, for instance, mobility or size and by, for instance, differential mobility analyzers (DMA) or mass spectrometers. Other methods and criteria for classification are possible according to the present invention and the preceding examples are not intended to limit the scope of the invention in any way.

A promoter covers all materials in gaseous, liquid, solid or any other form which promote, accelerate, or otherwise increase or improve the growth rate of nanomaterials or aid in controlling one or more properties of the nanomaterial produced or to be produced. Preferable promoters are sulfur, phosphorus or nitrogen elements or their compounds. For avoidance of doubt, CO₂ acts as a promoter according to the present invention, and, although it contains carbon, it is not a carbon source since it does not release contribute carbon to the synthesis as do carbon sources according to the invention. The promoter can act as a reagent for the reaction with a carbon source to alter its decomposition rate, and e.g. hydrogen can be used as such promoter. Other promoter compounds known in the art can be used according to the present invention and these examples are not intended to limit the scope of the invention in any way.

As the next step shown on FIG. 1, nanomaterial comprising carbon is synthesized from the released carbon. The synthesis may take place in the gas phase, liquid phase or solid phase, e.g. on a substrate. If a catalyst and/or promoter are introduced, the nanomaterial comprising carbon can be synthesized from the released carbon as well as interaction with the catalyst and/or promoter.

The nanomaterial comprising carbon synthesized by the method according to the present invention may be a high aspect ratio molecular structure (HARMs), graphene or fullerene. In case of HARMS, the nanomaterial may be a carbon nanotube (CNT), a carbon nanobud (CNB), a carbon nanowire, a carbon nanoribbon, a graphinated, carbon nanotube, a carbon nanohorn, a carbon fiber, a carbon peapod, a carbon nitrogen nanotube or a carbon boron nanotube.

In an optional step 106, the synthesized nanomaterial may be purified and/or functionalized by introducing a purifying and/or functionalizing reagent. Purification can be done, for example, to remove undesirable amorphous carbon or other reaction by-products, coatings and/or catalyst particles encapsulated in the carbon nanomaterial. As a purifying reagent, any compounds or their derivatives or decomposition products formed in situ in the reactor, which preferably react with amorphous carbon or other synthesis by-products rather than with the synthesized carbon nanomaterial (e.g. graphitized carbon in the case of CNTs), can be used. Examples of such reagents include alcohols, ketones, organic and inorganic acids. Other reagents are possible according to the present invention. Other reagents are possible according to the present invention and these examples are not intended to limit the scope of the invention in any way.

A functionalizing reagent can be used to attach one or more chemical groups to the nanomaterial comprising carbon to alter its properties. Functionalization the nanomaterials may change such properties such as solubility and electronic structure (for example, varying from wide band gap via zero-gap semiconductors to CNTs with metallic properties). As an example, functionalization such as doping of CNTs by lithium, sodium, or potassium elements leads to the change of the conductivity of CNTs, namely, to obtain CNTs possessing superconductive properties. According to the present invention, the functionalizing reagent can be introduced before, during or after the nanomaterial synthesis.

Purification processes are generally used to remove undesirable by-products, precursors or catalyst, such as amorphous carbon coatings, intermediate reaction products and/or catalyst particles encapsulated in or dispersed around the carbon nanomaterial. This procedure may take significant time and energy, often more than required for the nanomaterial production itself. In the present invention it is possible to have one or more separated heated nanomaterial reactors/reactor sections, where one reactor or section of the reactor is used to produce the carbon nanomaterials and the other(s) are used for, for instance, purification or functionalization such as doping. It is also possible to combine the growth and functionalization steps. Amorphous carbon, deposited on the surface of carbon nanomaterial, can be removed in one or more subsequent reactors/reactor sections by, for instance, heat treatment and/or addition of special compounds which, for instance, form reactive radicals (such as OH), which react with undesirable products rather than with carbon nanomaterial. One or more subsequent reactors reactors/sections can be used for e.g. the removal of catalyst particles from the carbon nanomaterial by creating the conditions where the catalyst particles evaporate or react. Other processing steps are possible according to the present invention.

If the synthesis is carried out e.g. as an aerosol process, all or a sampled part of the resulting raw nanomaterial product can be collected directly from the gas phase by means known in the art, and/or incorporated into a functional product material which can further be incorporated in devices.

### EXAMPLES

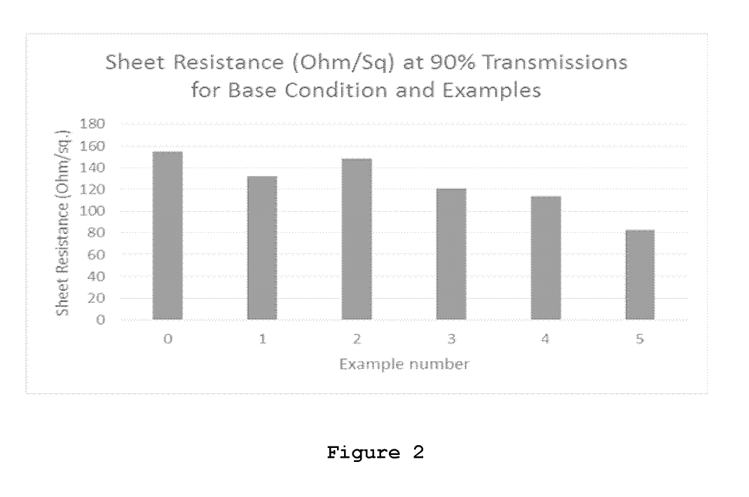

Unless otherwise stated, in the following examples, a resistively heated tubular furnace was used for carbon nanomaterial synthesis, ferrocene was used as precursor material for iron catalyst particles, carbon monoxide was used as carbon source 1, and the resulting aerosol product was collected on a nitrocellulose filter and transferred to a transparent polymer (PET) substrate for transmission and conductivity tests. The synthesized nanomaterial comprising carbon is carbon nanotubes (CNTs). The below examples are summarized in FIG. 2.

### Example 0

Single Carbon Source Base Case. This example is provided for comparison purposes only.

Single Carbon Source (Mole Fraction): CO (0.978)

Catalyst Precursor (Mole Fraction): Ferrocene (9.65e-6)

Promoter (Mole Fraction): CO2 (0.02214)

Reactor Peak Set Temperature: 840 C

Sheet Resistance at 90% Transmission: 155 Ohm/sq.

### Example 1

Carbon Source 1 (Mole Fraction): CO (0.986)

Carbon Source 2 (Mole Fraction): Toluene (1.03e-6)

Additional Carrier (Mole Fraction): N2 (2.76e-5)

Catalyst Precursor (Mole Fraction): Ferrocene (3.5e-6)

Promoter ((Mole Fraction): CO2 (0.01381)

Reactor Peak Set Temperature: 840 C

Sheet Resistance at 90% Transmission: 132 Ohm/sq.

### Example 2

Carbon Source 1 (Mole Fraction): CO (0.984)

Carbon Source 2 (Mole Fraction): Toluene (5.85e-6)

Additional Carrier (Mole Fraction): N2 (1.58e-4)

Catalyst Precursor (Mole Fraction): Ferrocene (3.5e-6)

Promoter (Mole Fraction): CO2 (0.01381)

Reactor Peak Set Temperature: 840 C

Sheet Resistance at 90% Transmission: 148 Ohm/sq.

### Example 3

Carbon Source 1 (Mole Fraction): CO (0.980)

Carbon Source 2 (Mole Fraction): Styrene (0.000503)

Additional Carrier (Mole Fraction): N2 (0.00051)

Catalyst Precursor (Mole Fraction): Ferrocene (4.6e-6)

Promoter (Mole Fraction): CO2 (0.01882)

Reactor Peak Set Temperature: 840 C

Sheet Resistance at 90% Transmission: 121 Ohm/sq.

### Example 4

Carbon Source 1 (Mole Fraction): CO (0.983)

Carbon Source 2 (Mole Fraction): Ethylene (0.000157)

Additional Carrier (Mole Fraction): None

Catalyst Precursor (Mole Fraction): Ferrocene (3.5e-6)

Promoter (Mole Fraction): CO2 (0.01652)

Reactor Peak Set Temperature: 840 C

Sheet Resistance at 90% Transmission: 114 Ohm/sq.

### Example 5

Carbon Source 1 (Mole Fraction): CO (0.662)

Carbon Source 2 (Mole Fraction): Ethylene (0.000208)

Additional Carrier (Mole Fraction): N2 (0.00051)

Catalyst Precursor (Mole Fraction): Ferrocene (8.2e-7)

Promoter 1 (Mole Fraction): CO2 (0.00621)

Promoter 2 (Mole Fraction): H2 (0.33115)

Promoter 3 (Mole Fraction): Thiophene (6.7e-7)

Reactor Peak Set Temperature: 860 C

Sheet Resistance at 90% Transmission: 83 Ohm/sq.

### Example 6

Carbon Source 1 (Mole Fraction): CO (0.662)

Carbon Source 2 (Mole Fraction): Ethylene (0.000167)

Additional Carrier (Mole Fraction): N2 (0.00051)

Catalyst Precursor (Mole Fraction): Ferrocene (8.2e-7)

Promoter 1 (Mole Fraction): CO2 (0.00621)

Promoter 2 (Mole Fraction): H2 (0.33115)

Promoter 3 (Mole Fraction): Thiophene (6.7e-7)

Reactor Peak Set Temperature: 860 C

Sheet Resistance at 90% Transmission: 97 Ohm/sq.

### Example 7

Carbon Source 1 (Mole Fraction): CO (0.662)

Carbon Source 2 (Mole Fraction): Ethylene (0.000125)

Additional Carrier (Mole Fraction): N2 (0.00051)

Catalyst Precursor (Mole Fraction): Ferrocene (8.2e-7)

Promoter 1 (Mole Fraction): CO2 (0.00621)

Promoter 2 (Mole Fraction): H2 (0.33115)

Promoter 3 (Mole Fraction): Thiophene (6.7e-7)

Reactor Peak Set Temperature: 860 C

Sheet Resistance at 90% Transmission: 131 Ohm/sq.

As can be seen on FIG. 2, multiple carbon sources are found to reduce the sheet resistance (i.e. increase the conductivity) at a given transparency. In the above examples 90% transmission of 550 nm wavelength light was the given transparency. Thus, and quality of conductive film is improved. Electrical Rate is defined as the conductivity produced over a given time or with a given material input. The increased conductivity also increases the yield and quality of conductive film by increasing the electrical rate.

The peak temperature used in the above examples, i.e. 860 C, is not to be understood as a limit or preferred temperature range for the method. Higher temperatures above 860 or other temperatures between 700 and 1300 C can further improve synthesis rates, yields and/or material quality, depending on, for instance, the decomposition temperature of the carbon sources used.

Similarly, a wider range of carbon source, reagent, catalysts and promoter mole fractions can be used. The examples above are not to be interpreted as a limit or preferred mole fraction range for the method. A wider range of conditions, e.g. mole fractions of carbon sources between 1:1 and 1000000:1, can further improve, for instance, synthesis rates, yields and/or material quality.

As it is clear to a skilled person, the invention is not limited to the examples described above but the embodiments can freely vary within the scope of the claims.

1. A method for producing nanomaterial comprising carbon, the method comprising:
introducing a combination of two or more carbon sources into a synthesis reactor;
decomposing at least partially the two or more carbon sources in the synthesis reactor to release carbon from the two or more carbon sources; and
synthesizing the nanomaterial comprising carbon from the released carbon in the synthesis reactor.

2. The method of claim 1, wherein decomposing at least partially the two or more carbon sources in the synthesis reactor to release carbon from the two or more carbon sources is done by providing energy to the synthesis reactor and/or by introducing a decomposing reagent.

3. The method of claim 1, further comprising introducing one or more promoters into the synthesis reactor.

4. The method of claim 1, further comprising introducing one or more catalysts into the synthesis reactor, wherein synthesizing the nanomaterial comprising carbon comprises synthesizing the nanomaterial comprising carbon from the released carbon and the one or more catalysts.

5. The method of claim 1, further comprising purifying the synthesized nanomaterial comprising carbon by introducing a purifying reagent.

6. The method of claim 1, further comprising functionalizing the synthesized nanomaterial comprising carbon by introducing a functionalizing reagent.

7. The method of claim 1, wherein at least one of the carbon sources is introduced as a liquid, aerosol or gas into the synthesis reactor.

8. The method of claim 1, wherein at least one of the carbon sources is selected from a group of: elemental carbon, a molecule or polymer containing one or more carbon atoms SP, SP2 or SP3 bonded to each other and/or to oxygen, one or more hydroxyl groups, nitrogen, one or more nitroso groups, one or more amine groups and/or one or more sulfonate groups, an organic compound, an oxide of carbon, a carbide, a carbonate and a cyanide.

9. The method of claim 8, wherein one or more of the organic compounds is a hydrocarbon or a carbohydrate.

10. The method of claim 4, wherein the catalyst is a bulk metal or alloy, or a material comprising a metal or an alloy.

11. The method of claim 1, wherein providing energy into the synthesis reactor is performed by heating.

12. The method of claim 1, wherein a combination of two carbon sources including a first carbon source and a second carbon source is introduced into the synthesis reactor.

13. The method of claim 12, wherein the molar ratio of the first carbon source to the second carbon source in the synthesis reactor is between 1:10000000 and 10000000:1.

14. The method of claim 1, wherein a combination of three carbon sources is introduced into the synthesis reactor.

15. The method of claim 1, wherein at least one of the carbon sources is carbon monoxide (CO).

16. The method of claim 1, wherein at least one of the carbon sources is ethylene or toluene.

17. The method of claim 1, wherein the nanomaterial comprising carbon is a high aspect ratio molecular (HARM) material comprising carbon, graphene or fullerene.

18. The method of claim 17, wherein the high aspect ratio molecular (HARM) material comprising carbon is a carbon nanotube (CNT), a carbon nanobud (CNB), a carbon nanowire, a carbon nanoribbon, a graphinated, carbon nanotube, a carbon nanohorn, a carbon fiber, a carbon peapod, a carbon nitrogen nanotube or a carbon boron nanotube.

19. The method of claim 1, further comprising introducing a substrate into the synthesis reactor, wherein synthesizing the nanomaterial comprising carbon from the released carbon comprises synthesizing the nanomaterial comprising carbon from the released carbon on the substrate.

20. Use of the method according to claim 1 in fabrication of a transistor, a flexible electronic device, a touch screen, a sensor, a photonic device, an electrode for a solar cell, a lighting device , a sensing device or a display device.

21. An apparatus for producing nanomaterial comprising carbon, the apparatus comprising means for performing the method according to claim 1.
